(19) United States
(12) Patent Application Publication
(10) Pub. No.: US 2004/0130079 A1
(43) Pub. Date: Jul. 8, 2004

(54) Gas spring damper unit

(76) Inventors: Henning Gold, Dorsheim (DE); Patrik Braun, Ronnenberg (DE); Stefan Beetz, Barmin (DE); Peter Kobs, Hamburg (DE)

Correspondence Address: Horst M Kasper, 13 Forest Drive, Warren, NJ, 07059, US

(21) Appl. No.: 10/469,849

(22) PCT Filed: Mar. 1, 2002
(86) PCT No.: PCT/DE02/00743

(30) Foreign Application Priority Data
Mar. 3, 2001 (DE) 101 10 321.2

(51) Int. Cl. F16F 9/14

(52) U.S. Cl. 267/64.23; 267/220

(57) ABSTRACT

Conventional gas spring damper units generally develop a lot of noise, which, in the first case, may be traced back to a lack of insulation in the upper support bearing. According to the invention, the upper support bearing (16) should thus be fitted with an additional pressure equalisation chamber (30) on the side of the rubber element (18), facing away from the spring chamber (12), which is connected to the spring chamber (12), by means of a pressure equalisation channel.

The Invention relates to a gas spring damper unit according to the preamble of claim 1.

Such pneumatic spring absorber units are employed in the motor vehicle industry in particular for suspending of vehicle wheels.

Spring damper units of any kind have the task to build up spring forces, wherein the spring forces oppose the load forces of the vehicle and develop the damping forces, in order to maintain the courses of motion of the vehicle body low in shocks and vibrations. For this purpose the spring damper units are in each case hinged to a lower support bearing and with an upper support bearing at the vehicle body of a vehicle.

So-called shock absorbers are known, which comprise in each case a mechanical spring for furnishing the spring forces and a pneumatic or hydraulic damper unit for furnishing the damping forces. Here the damper unit of the shock absorber is formed of a cylinder, of a double acting piston, and of two oppositely disposed pressure chambers, wherein the oppositely disposed pressure chambers are connected to each other through a throttle acting in two directions. Such a shock absorber is presented for example in the German printed Patent document DE 3716819 A1.

However also gas spring damper units are known, which develop their spring forces and their damping forces exclusively out of the pressures of an enclosed gas such as is described for example in the European Patent document EP 0160277 B1. This gas spring damper unit comprises essentially a cylinder casing and a piston with a piston rod shiftable and deplaceable in the cylinder casing. The piston and the piston rod are sealingly guided in the cylinder casing and thereby form two oppositely disposed pressure chambers changeable in volume by the motion of the piston, wherein the two pressure chambers are connected to each other through a throttle disposed in the piston. The part of the piston rod protruding from the cylinder casing is enclosed with airtight bellows, wherein the airtight bellows form a further volume changeable pressure chamber in the interior, wherein the further pressure chamber operates as a spring chamber and wherein the further pressure chamber is connected to the more remote pressure chamber in the cylinder casing and thereby forms a combined pressure damping chamber. This gas spring damper units is aligned in such an installation position in a way depending on the case of application that the upper support bearing connects the vehicle body either to the floor of the cylinder casing or to the head of the piston rod.

In all cases previously indicated, the upper support bearing between the vehicle body and the gas spring damper unit is furnished with a particular rubber element, wherein the rubber element is arranged between the metal parts of the vehicle body corresponding to each other and the gas spring damper unit.

This rubber element has the task to respond softly in case of forces acting axially onto the piston rod in order for the damper forces to remain as small as possible in case of small piston motions. The rubber element is correspondingly constructed in axial direction and in cardanic direction with a low spring stiffness. The rubber element has furthermore the task to receive radial and cardanic forces in order to lead the piston this way primarily and to relieve the piston from these forces and to prevent jams and seizing. Correspondingly, the rubber element is constructed with a higher spring stiffness in radial direction.

Now there results a particular disadvantage in particular with such gas spring damper units, which gas spring damper units connect with their upper support bearing the head of the piston rod of the gas spring damper unit and the vehicular body, which disadvantage comprises that the rubber element is one-sided loaded by the gas pressure in the spring chamber and is strongly pressed together based on the very low spring stiffness. However, the spring function of the rubber element in this direction is thereby more or less disabled and the piston is displaced from its predetermined center position. A strong development of noise and a shortened spring path of the piston in the one direction result as a consequence.

Therefore it is an object of the present Invention to further develop a gas spring damper unit of the kind recited such that the spring stiffness of the upper support bearing is furnished of equal size in the two spring directions at a low level.

This object is accomplished by the characterizing features of claim 1.

Further embodiments result from the subclaims 2 through 5.

The Invention eliminates the recited disadvantages of the state of the art.

A particular advantage of the Invention comprises here that both in the spring deflection stroke direction as well as in the rebound travel direction the same spring pre-load tensions and therewith the same spring stiffnesses are present and therewith also the same spring paths are available in the two directions. This reduces the noises between the vehicle body and the air spring damper unit, maintains the piston of the gas spring damper unit in the middle position and realizes therewith the same spring paths in the two directions.

The Invention is simple and can be realized with little production technological and financial expenditures.

The Invention is also very small and therewith space saving and therewith can also be applied under the most difficult installation conditions.

The Invention is to be illustrated in more detail by way of an embodiment example.

There is shown in:

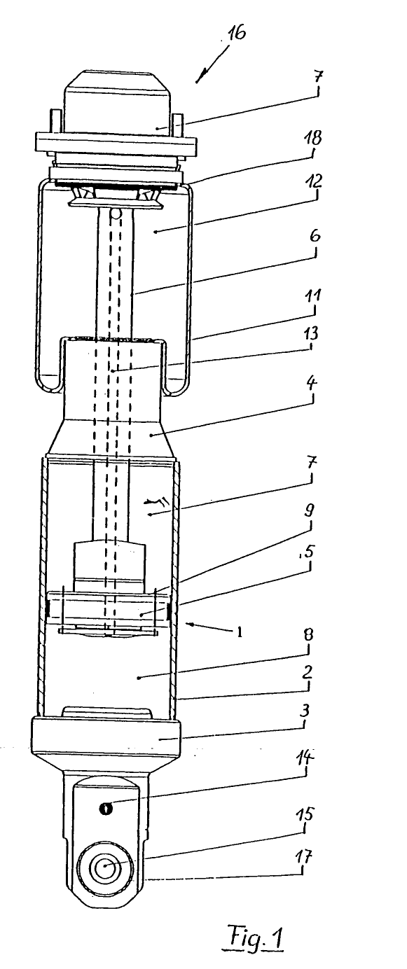

FIG. 1: a sectional view through a gas spring damper unit, and

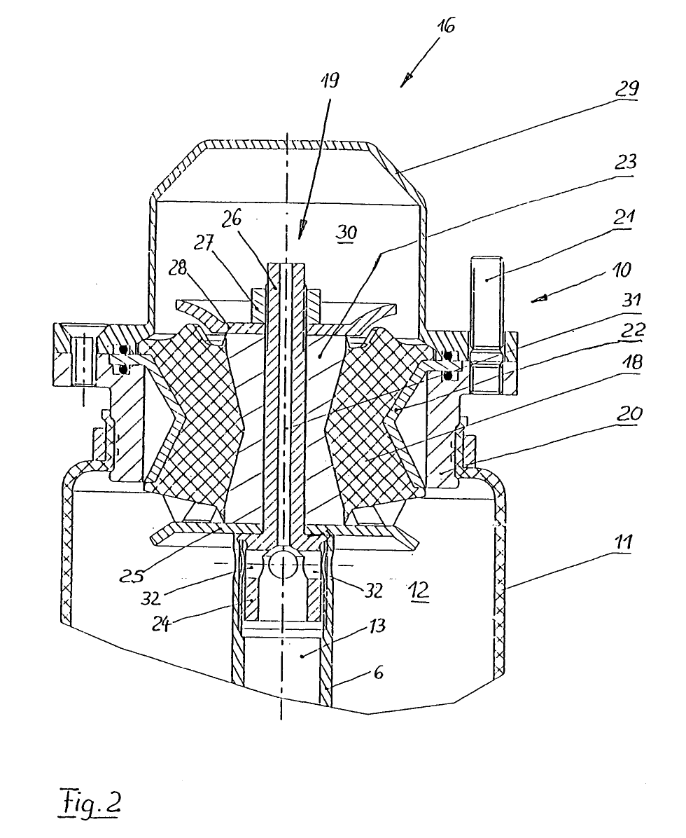

FIG. 2: a sectional view through the upper support bearing of the gas spring damper unit.

The gas spring damper unit comprises a cylindrical casing 1 with a casing wall 2, a casing foot 3, and a casing cover 4 according to FIG. 1. A piston 5 with a piston rod 6 is sealingly fitted in the casing 1 in a conventional way such that a first absorber chamber 7 and a second absorber chamber 8 are formed, wherein the first absorber chamber 7 and the second absorb a chamber 8 are connected to each other in two directions by a damping orifice 9. The piston rod 6 penetrates the casing 4 and is furnished with a piston rod head 10 at the free end of the piston rod 6. The part of the piston rod 6 protruding from the casing 1 is surrounded by a bellows 11, wherein the bellows 11 are attached on the one hand at the cylindrical casing 1 and on the other hand at the piston rod head 10 and wherein the bellows form a spring chamber 12 in the inside. This spring chamber 12 is connected to the more remote disposed second absorber chamber 8 through an axial channel 13 disposed in the piston rod 6, whereby a combined spring damper chamber results in this fashion. A compressed air connection 14 in the casing foot 3 is connected to an outer source of compressed air, wherein the compressed air generates a desired pressure in the complete compressed air system and maintains the desired pressure and a constant level of the pressure.

A lower support bearing 15 for connection to a wheel suspension of the vehicle is disposed at the casing foot 3 and an upper support bearing 16 for connection to the body of the vehicle is formed at the piston rod head 10.

The two support bearings 15, 16 are equipped each with a rubber element 17 and 18, wherein the rubber elements 17 and 18 are disposed between the metal parts for the wheel suspension or, respectively, for the body of the vehicle and the two elements 17 and 18 take care of an insulation of the sound vibrations.

Here the upper support bearing 16 with its rubber element 18 is formed in a particular way, as is shown in FIG. 2. The upper support bearing 16 comprises an inner support element 19, wherein the inner support element 19 is connected to the piston rod 6, an outer support element 20, wherein the outer support element 20 is attached to the body of the vehicle by screws 21, and the rubber element 18 is disposed in between. The inner support bearing 19, the rubber element 18, and the outer support bearing 20 are aligned here toward each other in a radial plane.

The rubber element 18 is equipped with a metal jacket 22 and with a metal core 23, wherein the metal jacket 22 is fixedly tensioned in an outer support element 20 and wherein the metal core 23 is rigidly connected to the inner support element 19. The metal core 23 is furnished with a receiver bore hole for connecting the metal core 23 to the inner support element 19, wherein the receiver bore hole is adapted in its dimensions to a cylinder part of the inner support element 19. The inner support element 19 furthermore has on the one hand a first threaded stem 24, wherein the first threaded stem 24 exhibits an outer threat for screwing together with the piston rod 6 and wherein the first threaded stem 24 is constructed larger in diameter and thus forms a bearing shoulder for a curved washer 25. A second threaded stem 26 with an attachment nut 27 and a second curved washer 28 shiftable on the cylinder part of the inner support element 19 is disposed on the other side of the inner support element 19 and thus disposed opposite to the first threaded stem 24. The rubber element 18 with its metal core 23 is slipped onto this inner support element 19 and the rubber element 18 is fixedly tensioned with the aid of the two curved washers 25, 28 and the fastening nut 27.

This upper support bearing 16 is airtight covered on the side of the body of the vehicle with a casing cover 29 according to the present Invention, whereby a pressure equalization chamber 30 is formed. This pressure equalization chamber 30 is connected to both the spring chamber 12 as well as also to the second damper chamber or absorber chamber 8 through an axial and passing through channel 31 in the inner support element 19, through the bore hole or axial channel 13 of the piston rod 6 and through radial channels 32 in the first threaded stem 24 and in the piston rod 6. The piston 5 with its piston rod 6 is charged with the same gas pressure from both sides in the region of the upper support bearing 16 while in the rest position of the piston 5. No different forces act on the piston 5 based on equally sized face ratios in the region of the upper support bearing 16, such that the piston 5 remains in its construction caused middle position.

The axial channel 31 and the radial channels 32 for connecting the spring chamber 12 and the pressure compensation and equalization chamber 30 are dimensioned in their realization such that such a flow-through resistance occurs upon flowing through this channel 31 that the flow-through resistance enables a pressure equalization under small piston speeds and impedes such a pressure equalization at larger piston speeds.

Gas spring damper units have the task to cushion oscillatory motions of the vehicle body relative to the wheels and initiated by the road tracks and to damp therewith the oscillatory motions such that the downward motion of the vehicle body is sensed to be central and such that the upward motion of the vehicle body leaves the wheels in attachment to the road surface.

A balanced pressure prevails in the pressure equalization chamber 30, in this spring chamber 12, in the second absorber chamber 8 and in the first absorber chamber 7 under rest conditions. The rubber element 18 is thereby nearly released and the piston 5 with the piston rod 6 disposed in a predetermined middle position.

Upon introduction of a force starting from the vehicle body and acting downwardly with a small speed, this force transfers in an equal way onto the outer support element 20 and onto the rubber element 18. A moment of force thereby operates onto the rubber element 18 between the outer support element 20 and the inner support element 19, wherein the moment of force compresses initially the rubber element 18 within the maximum spring path of the rubber element 18 and without that this moment of force is transferred to the piston rod 6. An equalized pressure results by volume compensation between the spring chamber 12 and the pressure equalization chamber 30, wherein the equalized pressure balances also the forces acting on the rubber element 18 and maintains the rubber element 18 in its nearly released middle position. The damping force is furnished in this phase solely by the spring stiffness of the rubber element 18.

Initially a block formation of the rubber element occurs upon introduction of a force with a larger speed. This force thereby transfers to the piston rod 6 through the now blocked rubber element 18 and displaces the piston 5 in the direction of the casing foot 3. The spring chamber 12 and the second absorber chamber 8 thereby are reduced in size, whereby the pressure rises in these chambers and the gas is displaced from these chambers. Thus gas flows from the spring chamber 12 into the second absorber chamber 8 through the axial channel 13 in the piston rod 6 and from the second absorber chamber 8 into the first absorber chamber 7 through the damping orifice 9. The flow-through resistance during flow-through of the damping orifice 9 determines thereby the damping force acting on the piston 5.

A volume compensation between the spring chamber 12 and the pressure equalization chamber 30 occurs again simultaneously through the axial channel 31 in the inner support element 19. A larger pressure loss occurs based on higher piston speeds during flow-through of the axial channel 13, wherein the larger pressure loss generates a smaller pressure relative to the spring chamber 12 in the pressure equalization chamber 30. A pressure difference acting from the spring chamber 12 operates thereby on the rubber element 18 and pretensions the rubber element 18 correspondingly and increases the spring stiffness of the rubber element 18. The flow resistances operate thereby in this phase as damping forces through the damping throttle 9.

Upon introduction of a force starting from the vehicle body and acting upwardly, reverse courses of motion occur in an analogous fashion.

List of Reference Characters

1 casing

2 casing wall

3 casing foot

4 casing cover

5 piston

6 piston rod

7 first absorber chamber

8 second absorb a chamber

9 damping orifice

10 piston rod head

11 bellows

12 spring chamber

13 axial channel

14 compressed air connector

15 lower support bearing

16 upper support bearing

17 lower rubber element

18 upper rubber element

19 inner support element

20 outer support element

21 screw

22 metal jacket

23 metal core

24 first threaded stem

25 first curved washer

26 second threaded stem

27 attachment nut

28 second curved washer

29 casing cover

30 pressure equalization chamber

31 axial channel

32 radial channel

1. Gas spring damper unit comprising
a cylindrical casing (1) with a piston (5) and a piston rod (6), which form together a first absorber chamber (7) becoming larger upon a spring deflection stroke and a second absorber chamber (8) becoming smaller upon a spring deflection stroke and
bellows (11), wherein the bellows (11) are attached at the piston rod (6) and at the casing (1) and wherein the bellows (11) form a spring chamber (12) becoming smaller upon a spring deflection stroke, wherein
the two absorber chambers (7,8) are connected to each other through a damping orifice (9) and wherein the absorber chamber (8) and the spring chamber (12) are connected to each other through an axial channel (13), and
the cylindrical casing (1) is connected to a wheel suspension of the vehicle through a lower support bearing (15) and wherein the piston rod (6) is connected to the body of the vehicle through an upper support bearing (16), wherein
the upper support bearing (16) comprises the rubber element (18), wherein the rubber element (18) is disposed in a radial plane with an inner support element (19) and an outer support element (20) and wherein the rubber element (18) is attached at the piston rod (6) with the inner support element (19) and is attached at the body of the vehicle with the outer support element (20),
characterized in that the upper support bearing (16) has an additional pressure equalizing chamber (30) on the side of the rubber element (18) disposed remote from the spring chamber (12), wherein the pressure equalizing chamber (30) is connected to the spring chamber (12) through a pressure balancing channel.

2. Gas spring damper unit according to claim 1,
characterized in that the pressure balancing channel has a passage flow resistance, wherein the passage flow resistance allows a pressure balancing only at small damper speeds.

3. Gas spring damper unit according to claim 2,
characterized in that the pressure balancing channel is formed of an axial channel (31) and the radial channels (32) in the inner support element (19).

4. Gas spring damper unit according to claim 3,
characterized in that the inner support element (19) is connected to the piston rod (6) and the radial channels (32) of the pressure balancing channel are incorporated in this threaded stem (24) and in the piston rod (6).

5. Gas spring damper unit according to claim 1,
characterized in that the pressure equalization chamber (30) is formed through a casing cover (29), wherein the casing cover (29) is solidly and airtight connected to the outer support element (20).
